(19) United States
(12) Patent Application Publication
(10) Pub. No.: US 2026/0139965 A1
(43) Pub. Date: May 21, 2026

(54) MAP CREATION FOR AUTONOMOUS DRIVING

(71) Applicant: Robert Bosch GmbH, Stuttgart (DE)

(72) Inventors: Erik Einhorn, Sarstedt (DE); Hans-Georg Raumer, Hildesheim (DE); Max Kirstein, Hohenhameln - Ot Bruendeln, (DE); Tobias Ritter, Hildesheim (DE)

(21) Appl. No.: 19/372,361

(22) Filed: Oct. 29, 2025

(30) Foreign Application Priority Data
Nov. 15, 2024 (DE) 10 2024 210 995.9

(51) Int. Cl. G01C 21/00

(52) U.S. Cl. CPC G01C 21/3841

(57) ABSTRACT

A method for training a generator of a generative adversarial network. First sensor data from at least a first type of sensor and recorded in a first spatial region are provided. The generator is then used to generate generated map data from the first sensor data. The generated map data are then compared with already available map data using a discriminator of the generative adversarial network, and a determination is made whether the generated map data can be distinguished from the already available map data. If the generated map data can be distinguished from the already available map data, at least one parameter for generating the generated map data is adjusted. The method is then repeated. The method is terminated when the generated map data can no longer be distinguished from the already available map data.

### CROSS REFERENCE

The present application claims the benefit under 35 U.S.C. § 119 of Germany Patent Application No. DE 10 2024 210 995.9 filed on Nov. 15, 2024, which is expressly incorporated herein by reference in its entirety.

### FIELD

The present invention relates to a method for creating a map. Parts of the method relate to training a generator of a generative adversarial network in order to be able to use the generator to create the map. The present invention also relates to a control method for a vehicle. Other aspects of the present invention relate to computing units and control devices for carrying out the methods.

### BACKGROUND INFORMATION

Certain methods in which vehicles use previously created maps to at least support the automated execution of a driving function are described in the related art. Creating the maps is laborious and expensive, however. Also described in the related art are certain generative adversarial networks, in which two networks, a generator and a discriminator are trained against each other, wherein the generator generates data that is very similar to an original data set and the discriminator attempts to distinguish between real and false data. After training, the generator can be used to generate data that is very similar to the original data. It is thus possible to generate a map from satellite images, for example.

### SUMMARY

An object of the present invention is to provide a method for training a generator of a generative adversarial network. Another object of the present invention is to provide a method for controlling a vehicle. Other objects of the present invention relate to computing units or control devices for carrying out the methods. These objects may be achieved by certain features of the present invention. Advantageous further developments of the present invention are disclosed herein.

According to a first aspect, the present invention relates to a method for training a generator of a generative adversarial network. A generative adversarial network can be referred to in English as a GAN (generative adversarial network), for instance. According to an example embodiment of the present invention, the method includes the steps discussed in the following.

First, first sensor data from at least a first type of sensor and recorded in a first spatial region are provided. The first type of sensor can in particular be a camera sensor or radar sensor or a LiDAR sensor. The first sensor data can be recorded using a sensor of the first type of sensor or a plurality of sensors. Multiple vehicles with a respective sensor of the first type of sensor may have been traveling in the first spatial region, for instance, and recorded first sensor data that is then made available. The first spatial region can refer to a spatially delimited region for which good map data are available, for example because said data have already been created manually. It can in particular be provided that the first sensor data are georeferenced; i.e., in addition to the measurement data from the sensor, the first sensor data also include position data and/or orientation data ascertained by GPS or another satellite navigation system and/or via an inertial navigation system. The vehicles can in particular be vehicles equipped with sensors. However, it can also be provided that already delivered and user-operated vehicles are used to generate the sensor data.

The generator is then used to generate generated map data from the first sensor data. The generated map data can include georeferenced objects and/or predicted sensor data from a further type of sensor, for example.

The generated map data are then compared with already available map data using a discriminator of the generative adversarial network, and a determination is made whether the generated map data can be distinguished from the already available map data. It is thus in particular possible to ascertain whether the generator of the generative adversarial network has already been trained sufficiently well.

If the generated map data can be distinguished from the already available map data, at least one parameter for generating the generated map data is adjusted. It can optionally be provided that a plurality of such parameters are adjusted. The method is then repeated; in particular the steps of generating the generated map data and comparing the generated map data to the already available map data.

The method is terminated when the generated map data can no longer be distinguished from the already available map data. The generator is then sufficiently well trained to interpret sensor data from a spatial region other than the first spatial region.

The generator and the discriminator can in particular be artificial neural networks.

In one example embodiment of the method of the present invention, second sensor data from at least a second type of sensor are provided. The generated map data are generated from the first sensor data and the second sensor data. The first type of sensor and the second type of sensor can in particular be different. The first type of sensor can be a camera sensor, for instance, and the second type of sensor can be a LiDAR sensor. The different types of sensors make it possible to improve the generation of the generated map data.

In one example embodiment of the method of the present invention, the generated map data include object data. The object data can then be output and used as a map, for example.

In one example embodiment of the method of the present invention, the generated map data include predicted sensor data from a further type of sensor. The predicted sensor data can then be output and, for example, used for vehicles that do not have the corresponding sensor.

In one example embodiment of the method of the present invention, after termination of the method, as soon as first sensor data and further sensor data recorded in a second spatial region are available, generating the generated map data, comparing the generated map data with the already available map data, and, if necessary, adjusting the parameter are repeated. This in particular makes it possible to use further sensor data from the second spatial region to improve the generator, even after the first training of the generator, as soon as sufficient measured sensor data from the second spatial region are available. This enables further improvement of the map creation. These method steps in particular make it possible to further improve the generator during the already occurring active use.

In one example embodiment of the method of the present invention, the generated map data and/or the parameter are output to a vehicle. If a plurality of parameters are provided, as described above, a plurality of parameters can also be output to the vehicle. Using the parameter or the parameters, the vehicle then parameterize its own generator, for example, which can be configured analogously to the generator of the generative adversarial network, and thus further process the sensor data ascertained by the vehicle using the trained generator.

According to a second aspect, the present invention relates to a computing unit comprising an input interface and a processor. The computing unit can optionally also comprise an output interface. The computing unit is configured to carry out the described method of the present invention. The sensor data can in particular be received via the input interface, which can be configured as an Internet interface, network interface or radio interface, for example. The generated map data and/or the parameter or the parameters can, for instance, be output to a vehicle via the output interface.

According to a third aspect, the present invention relates to a control method for a vehicle. According to an example embodiment of the present invention, the method includes the steps discussed in the following. First, one parameter or a plurality of parameters for generating generated map data and/or generated map data are received. Then, at least one driving function of the vehicle is controlled based on the parameter or the parameters and/or based on the map data. Controlling the driving function can in particular include a steering movement, influencing acceleration and/or braking.

In one example embodiment of the control method of the present invention, the parameter or the parameters are used to operate a generator in the vehicle to ascertain predicted sensor data of another type of sensor from the sensor data. These predicted sensor data can then also be used to control the driving function.

According to a fourth aspect, the present invention relates to a control device for a vehicle that is configured carry out one of the control methods of the present invention.

Embodiment examples of the present invention are discussed with reference to the figures.

### BRIEF DESCRIPTION OF THE DRAWINGS

FIG. 1 shows a flow chart of a method for training a generator of a generative adversarial network, according to an example embodiment of the present invention.

FIG. 2 shows a computing unit and a plurality of vehicles, according to an example embodiment of the present invention.

FIG. 3 shows a flow chart of a control method for a vehicle, according to an example embodiment of the present invention.

### DETAILED DESCRIPTION OF EXAMPLE EMBODIMENTS

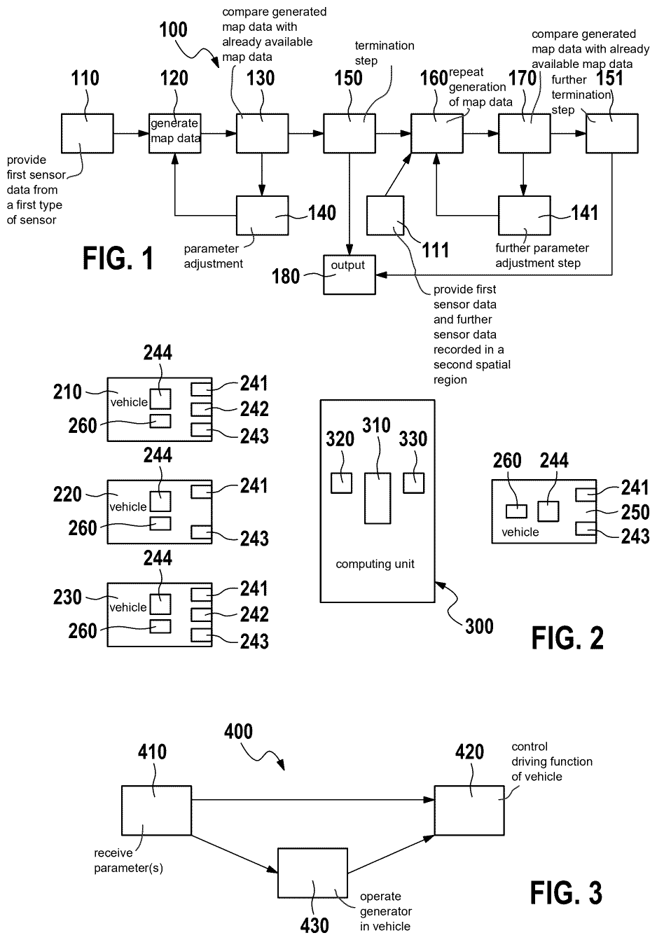

FIG. 1 shows a flow chart 100 of a method for training a generator of a generative adversarial network. A generative adversarial network can be referred to in English as a GAN (generative adversarial network), for instance. In a first method step 110, first sensor data from at least a first type of sensor and recorded in a first spatial region are provided. The first type of sensor can in particular be a camera sensor or radar sensor or a LiDAR sensor. The first sensor data can be recorded using a sensor of the first type of sensor or a plurality of sensors. Multiple vehicles, each equipped with a sensor of the first type of sensor, may have been traveling in the first spatial region, for instance, and recorded first sensor data that are then made available. The first spatial region can refer to a spatially delimited region for which good map data are available, for example because said data have already been created manually. It can in particular be provided that the first sensor data are georeferenced; i.e. in addition to the measurement data from the sensor, the first sensor data also include position data and/or orientation data ascertained by GPS or another satellite navigation system and/or via an inertial navigation system. The vehicles can in particular be vehicles equipped with sensors. However, it can also be provided that already delivered and user-operated vehicles are used to generate the sensor data.

In a second method step 120, the generator is used to generate generated map data from the first sensor data. The generated map data can include georeferenced objects and/or predicted sensor data from a further type of sensor, for example.

In a third method step 130, the generated map data are compared with already available map data using a discriminator of the generative adversarial network, and a determination is made whether the generated map data can be distinguished from the already available map data. It is thus in particular possible to ascertain whether the generator of the generative adversarial network has already been trained sufficiently well.

If the generated map data can be distinguished from the already available map data, at least one parameter for generating the generated map data is adjusted in a parameter adjustment step 140. It can optionally be provided that a plurality of such parameters are adjusted. The method is then repeated; in particular the steps of generating the generated map data and comparing the generated map data to the already available map data, i.e. the second method step 120 and the third method step 130.

The method is terminated with a termination step 150 when the generated map data can no longer be distinguished from the already available map data. The generator is then sufficiently well trained to interpret sensor data from a spatial region other than the first spatial region.

The generator and the discriminator can in particular be artificial neural networks.

In one embodiment example of the method, second sensor data from at least a second type of sensor are provided in the first method step 110. In the second method step, the generated map data are generated from the first sensor data and the second sensor data. The first type of sensor and the second type of sensor can in particular be different. The first type of sensor can be a camera sensor, for instance, and the second type of sensor can be a LiDAR sensor. The different types of sensors make it possible to improve the generation of the generated map data.

In one embodiment example of the method, the map data generated in the second method step 120 include object data. The object data can then be output and used as a map, for example.

In one embodiment example of the method, the map data generated in the second method step 120 include predicted sensor data from a further type of sensor. The predicted sensor data can then be output and, for example, used for vehicles that do not have the corresponding sensor.

FIG. 1 also shows optional method steps of another embodiment example of the method, which are discussed in the following. After the termination step 150 of the method, as soon as first sensor data and further sensor data recorded in a second spatial region are available and have been provided via a further first method step 111, the generation of the generated map data is repeated in a fourth method step 160. In a fifth method step 170, the generated map data are again compared with the already available map data.

If the map data generated in the fourth method step 160 can be distinguished from the already available map data, at least one parameter for generating the generated map data is adjusted in a further parameter adjustment step 141. It can optionally be provided that a plurality of such parameters are adjusted. The method is then repeated; in particular the fourth method step 160 of generating the generated map data and the fifth method step 170 of comparing the generated map data to the already available map data.

The method is terminated with a further termination step 151 when the generated map data can no longer be distinguished from the already available map data. This in particular makes it possible to use further sensor data from the second spatial region to improve the generator, even after the first training of the generator, as soon as sufficient measured sensor data from the second spatial region are available. This enables further improvement of the map creation. These method steps 160, 170, 141 in particular make it possible to further improve the generator during the already occurring active use.

FIG. 1 also shows an optional output step 180, which in one embodiment example of the method can be carried out after the termination step 150 and/or the further termination step 151. In the output step 180, the generated map data and/or the parameter are output to a vehicle. If a plurality of parameters are provided, as described above, a plurality of parameters can also be output to the vehicle. Using the parameter or the parameters, the vehicle then parameterize its own generator, for example, which can be configured analogously to the generator of the generative adversarial network, and thus further process the sensor data ascertained by the vehicle using the trained generator.

FIG. 2 shows a plurality of vehicles 210, 220, 230, 250 and a computing unit 300. A first vehicle 210 comprises a first sensor 241, a second sensor 242 and a third sensor 243. A second vehicle 220 comprises a first sensor 241 and a second sensor 243. A third vehicle 230 comprises a first sensor 241, a second sensor 242 and a third sensor 243. The first vehicle 210, the second vehicle 220, and the third vehicle 230 also comprise a communication interface 244.

The first sensor 241 can in particular be a camera sensor. The second sensor 242 can in particular be a radar sensor. The third sensor 243 can in particular be a LiDAR sensor. However, other assignments of these sensors are also possible. Via the communication interface 244, the vehicles 210, 220, 230 can forward sensor data, in particular from the first sensor 241, but also from the other sensors 242, 243, to the computing unit 300. For this purpose, the computing unit 300 comprises an input interface 320. As shown in FIG. 2, multiple vehicles 210, 220, 230, each equipped with a sensor 241 of the first type of sensor, may have been traveling in the first spatial region and recorded first sensor data that are then made available to the computing unit 300. The first spatial region can refer to a spatially delimited region for which good map data are available, for example because said data have already been created manually. It can in particular be provided that the first sensor data are georeferenced; i.e. in addition to the measurement data from the sensor, the first sensor data also include position data and/or orientation data ascertained by GPS or another satellite navigation system and/or via an inertial navigation system. The vehicles 210, 220, 230 can in particular be vehicles equipped with sensors. However, it can also be provided that already delivered and user-operated vehicles 210, 220, 230 are used to generate the sensor data.

In addition to the input interface 320, the computing unit 300 comprises a processor 310. The computing unit 300 can optionally also comprise an output interface 330. The computing unit 330 is configured to carry out the method discussed in connection with FIG. 1. The sensor data can in particular be received via the input interface 320, which can be configured as an Internet interface, network interface or radio interface, for example. This can relate in particular to the first method step 110 and the further first method step 111. Via the output interface 330, the generated map data and/or the parameter or the parameters can be output to a further vehicle 250 via a communication interface 244 of the further vehicle 250, thus carrying out the output step 180, for example. It is also possible to output the generated map data and/or the parameter or the parameters to the vehicles 210, 220, 230.

FIG. 3 shows a flow chart 400 of a control method for a vehicle comprising the steps discussed in the following. First, one parameter or a plurality of parameters for generating generated map data and/or generated map data are received in a receiving step 410. Then, at least one driving function of the vehicle is controlled based on the parameter or the parameters and/or based on the map data in a control step 420. Controlling the driving function can in particular include a steering movement, influencing acceleration and/or braking.

FIG. 3 also shows an optional generator step 430 of an embodiment example of the control method which is carried out between the receiving step 410 and the control step 420. In the generator step 430, the parameter or the parameters are used to operate a generator in the vehicle to ascertain predicted sensor data of another type of sensor from the sensor data. Using the generator step 430, the further vehicle 250 can use the sensor data from the first sensor 241 to calculate sensor data from a third sensor, for example, even though no third sensor is installed in the further vehicle 250. These predicted sensor data can then also be used to control the driving function and thus be included in the control step 420.

The control method discussed in connection with FIG. 3 can also be carried out by the vehicles 210, 220, 230.

FIG. 2 also shows that the vehicles 210, 220, 230, 250 each comprise a control device 260 for a vehicle that is configured to carry out one of the control methods of FIG. 3.

Although the invention has been described in detail with reference to the preferred embodiment examples, the invention is not limited to the disclosed examples and other variations can be derived from them by those skilled in the art without departing from the scope of protection of the invention.

What is claimed is:

1. A method for training a generator of a generative adversarial network, comprising the following steps:
providing first sensor data from at least a first type of sensor and recorded in a first spatial region;
generating generated map data from the first sensor data using the generator;
comparing the generated map data with already available map data using a discriminator of the generative adversarial network and determining whether the generated map data can be distinguished from the already available map data;
adjusting a parameter for generating the generated map data when the generated map data can be distinguished from the already available map data, and repeating the generating and the comparing steps; and
terminating the method when the generated map data can no longer be distinguished from the already available map data.

2. The method according to claim 1, wherein second sensor data from at least a second type of sensor are provided and the generated map data are generated from the first sensor data and the second sensor data.

3. The method according to claim 1, wherein the generated map data include object data.

4. The method according to claim 1, wherein the generated map data include predicted sensor data from a further type of sensor.

5. The method according to claim 4, wherein, after the termination of the method, as soon as first sensor data and further sensor data recorded in a second spatial region are available, generating the generated map data, comparing the generated map data with the already available map data, and, when necessary, adjusting the parameter are repeated.

6. The method according to claim 1, wherein the generated map data and/or the parameter are output to a vehicle.

7. A computing unit, comprising:
an input interface; and
a processor;
wherein the computing unit is configured to carry out a method for training a generator of a generative adversarial network, the method including the following steps:
providing first sensor data from at least a first type of sensor and recorded in a first spatial region,
generating generated map data from the first sensor data using the generator,
comparing the generated map data with already available map data using a discriminator of the generative adversarial network and determining whether the generated map data can be distinguished from the already available map data,
adjusting a parameter for generating the generated map data when the generated map data can be distinguished from the already available map data, and repeating the generating and the comparing steps, and
terminating the method when the generated map data can no longer be distinguished from the already available map data.

8. A control method for a vehicle, comprising the following steps:
receiving a parameter for generating generated map data and/or receiving generated map data; and
controlling at least one driving function of the vehicle based on the parameter and/or based on the map data.

9. The control method according to claim 8, wherein the parameter is used to operate a generator in the vehicle to ascertain from the sensor data predicted sensor data of another type of sensor.

10. A control device for a vehicle which is configured to:
receive a parameter for generating generated map data and/or receiving generated map data; and
control at least one driving function of the vehicle based on the parameter and/or based on the map data.
